(19) United States
(12) Patent Application Publication
(10) Pub. No.: US 2005/0117906 A1
(43) Pub. Date: Jun. 2, 2005

(54) Reconfigurable optical device for controlled insertion/dropping of optical resources

(75) Inventors: Arnaud Bisson, Orsay (FR); Sabry Khalfallah, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/999,996

(22) Filed: Dec. 1, 2004

(30) Foreign Application Priority Data
Dec. 2, 2003 (FR) 03 14 120

(51) Int. Cl. H04J 14/02

(52) U.S. Cl. 398/79

(57) ABSTRACT

An optical multiplexer device (D) is dedicated to inserting/dropping optical resources into or from an optical transmission line comprising incoming and outgoing optical fibers (F1, F2). The device (D) comprises: i) first coupler means (C1) having an inlet and an outlet connected respectively to the incoming optical fiber (F1) and to the outgoing optical fiber (F2), and an inlet/outlet (1) coupled to the inlet and the outlet; ii) both-way multiplexer/demultiplexer means (2) defining at least two internal channels (3) each connected to a primary inlet/outlet (ES1) coupled to the inlet/outlet (1) and comprising at least two secondary inlets/outlets (ES2) each connected to an internal channel (3); and iii) at least two send and/or receive modules (R, T) each coupled to a secondary inlet/outlet (ES2) by both-way light guide means (4′) fitted with optical processor means (5, 6) capable, on order, of taking up at least a reflection state reflecting an optical resource to the secondary inlet/outlet (ES2) that delivered it and a transmission state enabling an optical resource to be transferred between a send and/or receive module (R, T) and the associated secondary inlet/outlet (ES2), the optical power that is transmitted or reflected optionally being adjustable.

The invention relates to the field of equipment for communications networks, and more particularly to optical multiplexer devices for inserting/dropping multiplexed optical resources of the kind used for equipping certain pieces of equipment when they constitute network nodes.

The term “optical resources” is used herein to mean both wavelengths and wavelength bands.

Transferring multiplexed optical resources within a network is an operation that is complex. It frequently requires some information or resources to be inserted or dropped into or from resources that are being transferred, and this can happen at various levels. Such insertion and/or dropping generally takes place in network equipment, such as routers, constituting nodes of a network. More precisely, insertion and/or dropping is performed using optical multiplexer devices for inserting/dropping multiplexed optical resources, which devices are connected to incoming and outgoing optical fibers of an optical transmission line in which the optical resources are traveling.

Such devices are connected directly or via an optical amplifier to the incoming optical fiber (or upstream fiber).

Some such devices comprise firstly an optical coupler used for taking a fraction of the wavelength division multiplexed signal from the outlet of the incoming fiber in order to transfer said fraction via an outlet to a first demultiplexer of the 1 to N type delivering demultiplexed resources on N outlets. Access to resources that are to be processed locally, e.g. for the purpose of receiving the data they contain or for regenerating the data, takes place via said outlets. The other outlet from the coupler feeds an optical system used for allowing those resources that need to be forwarded to the outgoing optical fiber to transit through the equipment. The other resources are blocked by the device. The device is generally constituted by a demultiplexer, with each of its outlets connected to an optical attenuator module, e.g. of the variable optical attenuator (VOA) type, and a multiplexer for grouping together the resources. The resources as regrouped in this way are then forwarded to the first inlet port of a second coupler whose second inlet port is used for adding in new resources that have previously been grouped together by another multiplexer. The outlet port from said second coupler then feeds the outgoing optical fiber either directly or via an amplifier.

Because such devices comprise four multiplexer or demultiplexer components, they are expensive and bulky. In addition, such devices lead to high insertion losses between the incoming fiber and the outgoing fiber which can degrade the resources even when optical amplifier modules are used on either side of the device.

In order to attempt to improve the situation, several solutions have been proposed. Amongst such solutions, mention can be made in particular of that described in patent document GB 2 381 683.

That solution consists in providing a device that comprises:
an optical circulator having an inlet and an outlet respectively connected to an incoming optical fiber and an outgoing optical fiber, and an inlet/outlet that is coupled to said inlet and to said outlet; and
both-way multiplexer/demultiplexer means comprising a primary inlet/outlet coupled to the inlet/outlet of the first coupler means, and secondary inlets/outlets, and defining internal channels (or ports) connected to the primary inlet/outlet and to the secondary inlets/outlets, which inlets/outlets are also coupled to light guide means each subdivided into a both-way portion terminated by a reflector and two one-way portions connected respectively to a send module and to a receive module.

Such a device does indeed make it possible to use only two demultiplexer or multiplexer components, but it requires firstly that each channel should be associated with three light guide portions, which is bulky, and secondly that each portion should be fitted with an amplifier module such as a semiconductor optical amplifier (SOA), which can be expensive both at manufacture and during maintenance.

No known solution provides full satisfaction and the invention thus seeks to improve the situation.

To this end, the invention provides an optical multiplexer device for inserting/dropping multiplexed optical resources for an optical transmission line comprising at least an incoming optical fiber and an outgoing optical fiber, the device comprising firstly first coupler means having an inlet and an outlet connected respectively to the incoming and outgoing optical fibers, and an inlet/outlet coupled to said inlet and to said outlet, and secondly both-way multiplexer/demultiplexer means comprising a primary inlet/outlet coupled to the inlet/outlet of the first coupler means, and at least two secondary inlets/outlets, and defining at least two internal channels connected to the primary inlet/outlet and to the secondary inlets/outlets.

That optical device is characterized by the fact that it includes at least two send and/or receive modules each coupled to a secondary inlet/outlet by both-way light guide means, the modules being fitted with optical processor means connected in series and capable, on order, of placing themselves in a selected one of at least a reflection state for reflecting an optical resource towards the secondary inlet/outlet that delivers it, and a transmission state for enabling an optical resource to be transferred (inserted or dropped) between a send and/or receive module and the secondary inlet/outlet to which it is coupled.

The term “send and/or receive module” is used herein to mean either a send module, or a receive module, or indeed a module subdivided into a send module and a receive module.

The device of the invention may include other characteristics that can be taken separately or in combination, and in particular:
each send and/or receive module may be subdivided into a send module and a receive module, and its both-way light guide means may each be coupled to a send module and to a receive module via an auxiliary coupler means, for example a coupler of the 1 to 2 type or an optical circulator;
each send and/or receive module may be subdivided into a send module and a receive module, and its both-way light guide means may each include second and third portions coupled firstly respectively to a send module and to a receive module, and secondly to an auxiliary coupling means connected to one of the secondary inlets/outlets. In which case, the optical processor means may be implanted, for example, in the second and/or third portions. In addition, it is also possible under such circumstances to provide a second coupler means comprising an inlet and an outlet coupled respectively to other incoming and outgoing optical fibers, and an inlet/outlet coupled to the inlet and the outlet. The both-way multiplexer/demultiplexer means then comprise another primary inlet/outlet coupled to the inlet/outlet of the second coupler means, and at least two other secondary inlets/outlets, and define at least two other internal channels each connected to said other primary inlet/outlet and to one of the other secondary inlets/outlets. Furthermore, provision can also be made for at least two other send and/or receive modules each coupled to one of the other secondary inlets/outlets by both-way light guide means fitted with optical processor means;
its optical processor means may be capable of placing themselves in at least one reflection state with attenuation for reflecting an optical resource while attenuating its intensity to the secondary inlet/outlet that delivered it;
its optical processor means may be capable of placing themselves in at least one transmission state with attenuation for enabling a resource to be transferred (inserted or dropped) with attenuated intensity between one of the send and/or receive modules and the secondary inlets/outlets to which it is coupled;
its optical processor means may comprise reflector means of reflection capacity that is adjustable as a function of received configuration orders (or instructions or signals). For example, the reflection means may be micro-electromechanical systems (MEMS) comprising a variable-position mirror capable of taking up at least a total reflection position, a partial transmission and/or reflection position, and a total transmission position;
its optical processor means may comprise total shut-off means capable of co-operating with the reflector means to define the state of reflection with attenuation. For example, the second optical processor means may be MEMSs each capable of taking at least a total shut-off position and a total transmission position. In a variant, the optical processor means may comprise VOA type means capable of co-operating with reflector means in order to define the state of transmission with attenuation and the state of reflection with attenuation;
the both-way multiplexer/demultiplexer means may define at least one other internal channel connected firstly to an inlet and secondly to another primary inlet/outlet coupled to a second coupler means installed on the outgoing optical fiber downstream from the first coupler means. Each secondary inlet/outlet is then coupled to a receive module by the both-way light guide means, and at least one send module coupled to the input of the both-way multiplexer/demultiplexer means is provided so as to act on order to feed it with an optical resource. In which case, each send module may be coupled to an inlet via one-way light guide means fitted with shutter means capable, on order, of occupying at least a shutter state preventing a resource from accessing one of the inlets, and a transmission state enabling a resource to be transferred (inserted or dropped) between one of the send modules and one of the inlets. By way of example, such shutter means may be MEMSs capable of taking up a total shut-off position and a total transmission position;
the first and/or second coupler means may be constituted by an optical circulator; and
its both-way multiplexer/demultiplexer means may be implemented in the form of a grating wavelength selector of the arrayed waveguide grating (AWG) type, in particular when the optical resources are wavelengths.

The invention is particularly well adapted, although not exclusively, to the field of optical communications, in particular when the optical resources are wavelengths or wavelength bands.

Other characteristics and advantages of the invention appear on examining the following detailed description and the accompanying drawings, in which:

FIG. 1 is a diagram showing a first embodiment of an optical multiplexer device in accordance with the invention for inserting/dropping optical resources;

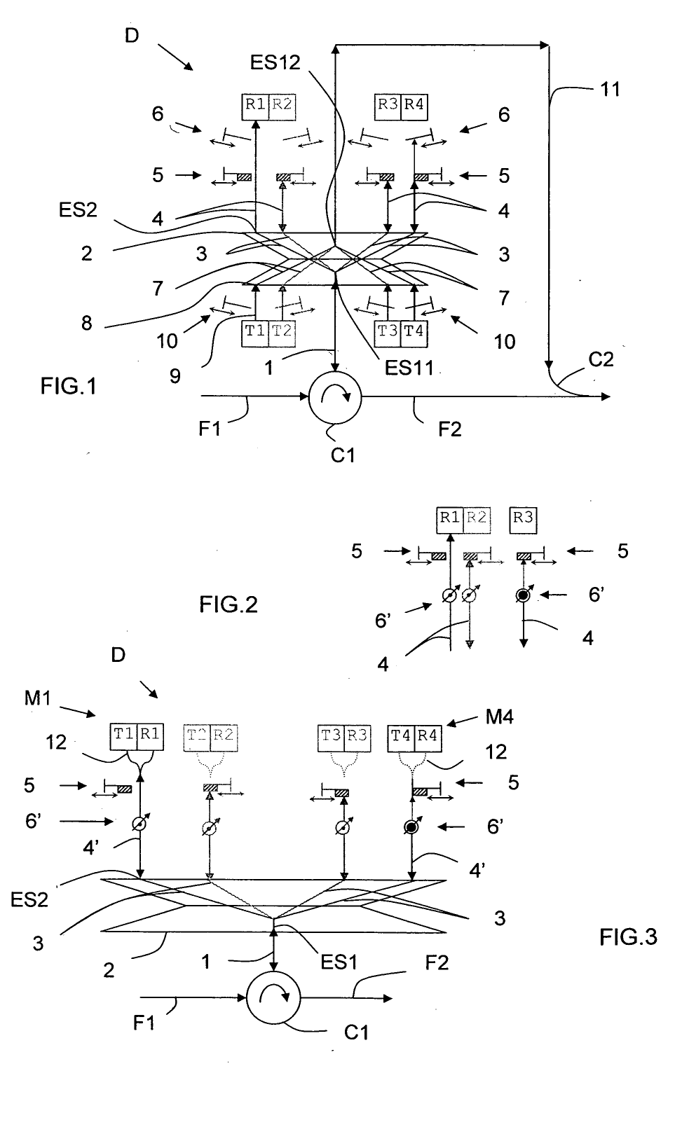

FIG. 2 is a diagram showing a first variant of the optical processor means of the FIG. 1 device;

FIG. 3 is a diagram showing a second embodiment of an optical multiplexer device of the invention for inserting/dropping optical resources;

FIG. 4 is a diagram showing a variant of the optical processor means fitted to a variant of the light guide means of the FIG. 3 device;

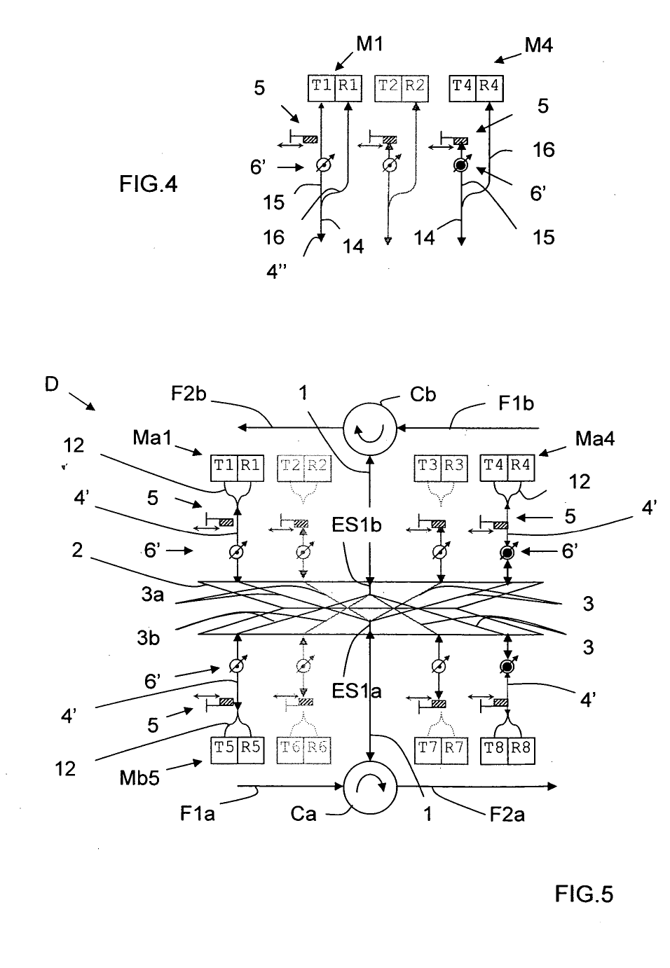

FIG. 5 is a diagram showing a third embodiment of an optical multiplexer device of the invention for inserting/dropping optical resources; and

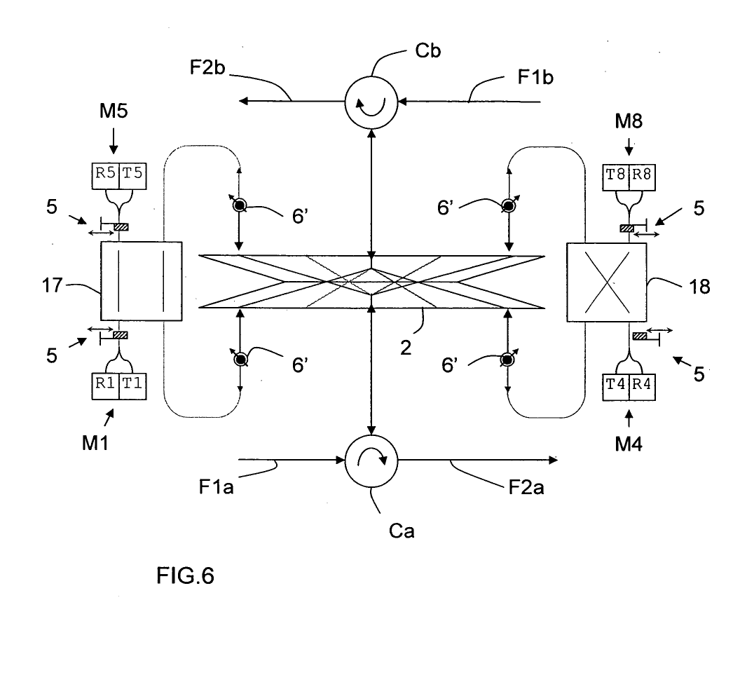

FIG. 6 is a diagram showing a fourth embodiment of an optical multiplexer device of the invention for inserting/dropping optical resources.

The accompanying drawings contribute not only to describing the invention, but may also contribute to defining it, where appropriate.

The invention seeks to enable optical resources to be inserted and dropped into and from an optical transmission line belonging to a communications network, for example.

Reference is made initially to FIG. 1 while describing a first embodiment of an optical multiplexer device for inserting/dropping optical resources and implementing the invention. By way of example, such a device D may be integrated in network equipment constituting a network node, such as a router, connected to at least one optical transmission line constituted at least by an incoming optical fiber F1 and an outgoing optical fiber F2 adapted for transmitting multiplexed optical resources.

In the description below, it is assumed that the optical resources that are inserted and dropped are wavelengths, however they could equally well be wavelength bands.

The device D shown comprises firstly first coupler means C1 comprising an inlet and an outlet connected respectively to the incoming optical fiber F1 and the outgoing optical fiber F2, and also an inlet/outlet 1 coupled to its inlet and outlet. The first coupler means C1 is implemented in this case in the form of an optical circulator.

The device D also comprises both-way multiplexer/demultiplexer means 2 comprising in particular a first primary inlet/outlet ES11 coupled to the inlet/outlet 1 of the optical circulator C1.

These both-way multiplexer/demultiplexer means 2 serve both to demultiplex and to multiplex optical resources. These means are constituted by an optical multiplexer and demultiplexer (OMAD), e.g. implemented in the form of a wavelength selector of the arrayed waveguide grating (AWG) type.

Such an OMAD 2 defines at least two internal channels 3, each connected firstly to its first primary inlet/outlet ES11 and secondly to a respective one of its secondary inlets/outlets ES2. Each internal channel 3 is arranged in such a manner as to enable optical resources presenting a selected wavelength to be demultiplexed and/or multiplexed.

In the example shown, each inlet/outlet ES2i (in this case i=1 to 4, but i could take any value greater than or equal to 2) of the OMAD 2 is coupled to light guide means 4i (represented by a one-way or a both-way arrow) fitted with optical processor means 5i and 6i and coupled to a receive module Ri. These light guide means 4i are of the both-way type in this case. They are preferably implemented in the form of optical fibers, but they could also be devised differently, and in particular in the form of planar waveguides.

In this case, each waveguide 4i is fitted with two optical processor means 5i and 6i connected in series and arranged in such a manner as to be capable together of defining at least two states: a reflection state for reflecting an optical resource towards the secondary inlet/outlet ES2i that delivered it, and a transmission state enabling an optical resource to be conveyed (or transferred) from the secondary inlet/outlet ES2i that delivered it to one of the receive modules Ri with which it is coupled.

For example, and as shown diagrammatically, each first optical processor means 5i is a (first) reflector means presenting a capacity for reflection that is adjustable as a function of configuration orders (or instructions or signals). By way of example, it can be implemented in the form of a micro-electromechanical system (MEMS) comprising a variable-position mirror capable of occupying at least a total reflection position (to reflect the signals for returning to the outgoing fiber F2), a position of partial and adjustable reflection and/or transmission (for reflection with attenuation), and a total transmission position (for transmission without attenuation to the receiver Ri). This sliding mirror can be housed in a space formed between two waveguide portions 4i, so as to be capable of obstructing the sections thereof, in full, in part, or not at all.

In this case, each (optional) second optical processor means 6i serves to co-operate with the associated reflector means 5i in order to block the residual signal coming from partial reflection (in said first reflector means 5i), thereby defining the state of reflection with attenuation. For example, it can be implemented in the form of a second reflector means, such as a MEMS capable of taking a total shut-off position and a total transmission position. For example, in the total shut-off position, the light signals are reflected in a direction which prevents them from being reintegrated in the light guide means 4.

In the configuration shown in FIG. 1: firstly the first and second optical processor means 5 and 6 of the waveguide 4 coupled to the first receive module R1 (furthest to the left) are both in their total transmission state so that the optical resources that reach the first internal channel 3 of the OMAD 2 can feed said first receive module R1; secondly the first and second optical processor means 5 and 6 of the light guides 4 coupled to the second and third receive modules R2 and R3 are both in their total shut-off state so that the optical resources which reach the second and third internal channels 3 of the OMAD 2 are reflected towards its first primary inlet/outlet ES11 so as to be reinjected into the outgoing optical fiber F2 by the circulator C1; and thirdly the first and second reflector means 5 and 6 of the waveguide 4 coupled to the fourth receive module R4 (furthest to the right) are respectively in a partial transmission state and in a total shut-off state so that the optical resources that reach the fourth internal channel 3 of the OMAD 2 are reflected to its first primary inlet/outlet ES11 so as to be reinjected, after attenuation, into the outgoing optical fiber F2 by the circulator C1. The residual signal from the first optical processor means 5 is then blocked by the second optical processor means 6 so that no signal reaches the receive module R4.

In a variant, and as shown in FIG. 2, the second optical processor means 6i may be implemented in the form of variable optical attenuator (VOA) type means 6′. In which case, the first reflector means Si are preferably placed closer to the receive module Ri than the VOAs 6′.

Furthermore, as shown in FIG. 1, the OMAD 2 also has a second primary inlet/outlet ES12 connected to at least one other internal channel 7j (j=1 to 4, but j may have any value greater than or equal to 1), and each connected to a respective inlet 8j. Each inlet 8 of the OMAD 2 is coupled to a send module Tj via at least one light guide means 9j (represented by a one-way arrow), optionally fitted with optical processor means 10j. In this case these light guide means 9i are of the one-way type. They are preferably implemented in the form of planar technology light guides (or more simply in the form of optical fibers).

The second primary inlet/outlet ES12 is also coupled to the outgoing optical fiber F2 downstream from the circulator C1 by another light guide means 11 and a second coupler means C2. In this case the light guide means 11 is of the one-way type. It is preferably implemented in the form of an optical fiber. In this case the second coupler means C2 is implemented in the form of an optical Y coupler, i.e. it constitutes a 2 to 1 type coupler.

In this case, each waveguide 9j is fitted with optical processor means 10j arranged to be capable of defining at least two states: a total shut-off state for blocking any optical resource sent by the send module Tj; and a total transmission state enabling an internal channel 7j to be fed with the optical resource.

By way of example, and as shown diagrammatically, each optical processor means 10j is implemented in the form of a “shutter” means such as a MEMS comprising a variable-position shutter capable of occupying a total shut-off position and a total transmission position.

In the configuration shown in FIG. 1: firstly the shutter means 10 of the waveguide 9 coupled to the first send module T1 (the furthest to the left) is in its total transmission state so that the optical resources that reach the first internal channel 7 of the OMAD 2 can be directed to the second primary inlet/outlet ES12 so as to be injected (or inserted) into the outgoing optical fiber F2 via the waveguide 11 and the coupler T2; and secondly the reflector means 10 of the waveguides 9 coupled to the second, third, and fourth send modules T2, T3, and T4 are all in their total shut-off state such that the optical resources are shut off without being capable of reaching the OMAD 2.

Reference is now made to FIG. 3 to describe a second embodiment of an optical device D of the invention. This second embodiment is a compact variant of the device D described above with reference to FIGS. 1 and 2. Consequently, elements that are common to both embodiments are designated by references that are identical or partially identical, and are not described again in detail.

In this case, the OMAD 2 has only one series i of both-way internal channels 3i (in this case i=1 to 4, but i could have any value greater than or equal to 2), each channel being connected firstly to its first (and sole) primary inlet/outlet ES1 which in turn is connected to the inlet/outlet 1 of the circulator C1, and secondly to one of its secondary inlets/outlets ES2i. Furthermore, each secondary inlet/outlet ES2i is coupled to a send and receive module Mi, constituted by a receive module Ri and a send module Ti, e.g. two juxtaposed modules, via both-way type light guide means 4′ and 12.

By way of example, the light guide means 12 is a Y coupler connected firstly to one end of the guide means 4′ and secondly to the send module Ti and to the receive module Ri. However, in a variant, the light guide means 12 may be implemented in the form of planar waveguide portions or indeed in the form of a circulator provided with an inlet/outlet connected to the waveguide 4′, an outlet connected to the receive module Ri, and an inlet connected to the send module Ti.

Where necessary, this embodiment makes it possible not only to attenuate the reflected or dropped (for sending to a receive module Ri) light signals to be attenuated, but also enables those resources that are to be inserted into the optical fiber FO to be attenuated.

In this case, the optical processor means 5 and 6′ are fitted to the portions 4′ of the light guide means, e.g. implemented in the form of planar technology waveguides.

In this case the second optical processor means 6′ are preferably implemented in the form of VOA type means, like the variant shown in FIG. 2.

In the configuration shown in FIG. 3: firstly the first and second optical processor means 5 and 6′ of the waveguide 4′ coupled to the first send and receive module M1 (the furthest to the left) are both in their total transmission state so that the optical resources which reach the first internal channel 3 of the OMAD 2 can be fed to the first receive module R1 without attenuation and the optical resources coming from the first send module T1 can be fed without attenuation to the first internal channel 3 of the OMAD 2 for insertion into the outgoing optical fiber F2; secondly the first and second optical processor means 5 and 6′ of the waveguides 4′ coupled to the second and third send and receive means M2 and M3 are both in their total reflection (or shut) state so that the optical resources that reach the second and third internal channels 3 of the OMAD 2 are reflected to its first primary inlet/outlet ES1 so as to be reinjected into the outgoing optical fiber F2 by the circulator C1; and thirdly the first optical processor means of the waveguide 4′ coupled to the fourth receive module R4 (the furthest to the right) are in a partial reflection state, and the second processor means 6′ are in a partial attenuation state, such that the optical resources that reach the fourth internal channel 3 of the OMAD 2 can be reflected with attenuation towards the fourth internal channel 3 of the OMAD 2 in order to be reinserted into the outgoing optical fiber F2, or else sent by the send module T4 in order to be introduced into said fourth internal channel 3 after being attenuated.

As shown in FIG. 4, a variant embodiment can be envisaged in which the insertion of optical resources is controlled for each send and/or receive module Mi by reflector means 5i and by optical attenuator means 6′i, e.g. of the VOA type. For this purpose, the light guide means 4″i associated with each internal channel 3i and with each send and receive module Mi are implemented in the form of a first portion 14i extended by second and third portions 15i and 16i connected respectively to the send module Ti and to the receive module Ri. In this case, only the portion 15i dedicated to the send module Ti is provided with reflector means 5i and optical attenuator means 6′i. However, in a variant, it is possible to envisage each portion 15i and 16i being fitted both with reflector means 5i and with optical attenuator means 6′i.

This configuration is advantageous since it enables a signal to be forwarded to the receive module Ri at a power that does not depend on the attenuation applied by the attenuator 6′i to the resources sent by the send module Ti.

Naturally, other variants could be envisaged in which each second portion 15i and each third portion 16i is fitted with its own processor means.

Reference is made to FIG. 5 while describing a third embodiment of an optical device D of the invention. This third embodiment is a variant of the device D described above with reference to FIGS. 3 and 4. Consequently, elements that are common to these two embodiments are designated by references that are identical or identical in part, and they are not described again in detail.

In this case, the device D is arranged so as to enable optical resources coming from or going to two pairs (a and b) of incoming optical fibers (F1a, F1b) and outgoing optical fibers (F2a, F2b) to be inserted and dropped using a single OMAD 2. For this purpose, it has two examples of the elements of the second embodiment and an adaptive OMAD 2 which defines internal channels 3a and 3b for inserting/dropping optical resources respectively in the first optical fibers (a) and the second optical fibers (b).

More precisely, the OMAD 2 has a first primary inlet/outlet ES1a connected to a first circulator Ca (or the equivalent) and to i internal channels 3ai (in this case i=1 to 4, but i could have any value greater than or equal to 2), and a second primary inlet/outlet ES1b connected to a second circulator Cb (or the equivalent) and to k internal channels 3bk (in this case k=i=1 to 4, but k could take any value greater than or equal to 2). The first circulator Ca is connected to the first incoming and outgoing optical fibers F1a and F2a, while the second circulator Cb is connected to the second incoming and outgoing optical fibers F1b and F2b. Furthermore, the internal channels 3ai and 3bk are respectively connected to send and receive modules Ma and Mb.

By means of this configuration, it is possible to extract optical resources coming from the incoming optical fiber F1a (or F1b) either to feed at least one of the receive modules Ri (or Rk) after being demultiplexed by the internal channel 3ai (or 3bk) of the OMAD 2, or else to be reinserted into the outgoing optical fiber F2a (or F2b) after being reflected and possibly attenuated. Furthermore, it is possible to insert optical resources coming from at least one of the send modules Ti (or Tk) into the outgoing optical fiber F2a (or F2b), possibly after attenuation.

It is also possible to envisage transferring optical resources from one of the optical fibers to the other optical fiber by establishing connections between the send and receive modules Mai and Mbk. Such a situation is shown in FIG. 6. Although not visible in FIG. 6, the device reproduces the structure shown in FIG. 3, but may of the elements are omitted in order to avoid overcrowding the figure.

More precisely, this configuration consists in sending a signal coming from a port (or internal channel) 3ai (or 3bk) to a port 3bk (or 3ai). For this purpose, and for flexibility purposes, it is possible to use 2×2 type optical switches 17 and 18, for example.

The switch 17 has a first inlet/outlet connected to the secondary inlet/outlet ES2 of the first internal channel 3a-1, a second inlet/outlet connected to the first send and receive module M1 (T1, R1), a third inlet/outlet connected to the secondary inlet/outlet ES2 of the first internal channel 3b-1, and a fourth inlet/outlet connected to the fifth send and receive module M5 (T5, R5). Similarly, the switch 18 comprises a first inlet/outlet connected to the secondary inlet/outlet ES2 of the fourth internal channel 3a-4, a second inlet/outlet connected to the fourth send and receive module M4 (T4, R4), a third inlet/outlet connected to the secondary inlet/outlet ES2 of the fourth internal channel 3b-4, and a fourth inlet/outlet connected to the eighth send and receive module M8 (T8, R8).

By configuring the switch 17 as shown in the left-hand portion of FIG. 6, for example, it is possible to transfer optical signals from the incoming fiber F1a or F1b to the outgoing fiber F2b or F2a via the internal channels 3a-1 and 3b-1. Furthermore, by configuring the switch 18 as shown in the right-hand portion of FIG. 6, for example, it is possible to transfer optical signals from the incoming fiber F1a to the receive module R4 and to re-send them by the send module T4, and to return the optical signal coming from the incoming fiber F1b directly to the outgoing fiber F2b after attenuating their intensity.

Numerous other combinations can be envisaged. Thus, for example, it is possible to connect the ports of the send modules Ti and the receive modules Ri directly to the corresponding secondary inlets/outlets ES2i in order to redirect a channel. Furthermore, in the example shown in FIG. 6, only two 2×2 switches are shown, but a switch could be associated with each “pair” of internal channels (3a-i, 3b-i), or with only some of them, or indeed only one of them.

The invention provides an optical multiplexer device for inserting/dropping optical resources that is compact, of low cost, easy to integrate (because it can be implemented using planar technology), and presenting low insertion losses (since it does not require a coupler upstream from its demultiplexer means).

The invention is not limited to the embodiments of the optical device and the network equipment as described above, merely by way of example, but covers any variant that could be envisaged by the person skilled in the art within the ambit of the following claims.

1. An optical multiplexer device (D) for inserting/dropping optical resources for an optical transmission line comprising at least an incoming optical fiber (F1) and an outgoing optical fiber (F2), said device (D) comprising firstly first coupler means (C1, Ca) having an inlet and an outlet connected respectively to the incoming and outgoing optical fibers (F1, F2), and an inlet/outlet (1) coupled to said inlet and to said outlet, and secondly both-way multiplexer/demultiplexer means (2) defining at least two internal channels (3) each connected to a primary inlet/outlet (ES1, ES11) coupled to said inlet/outlet (1) of said first coupler means (C1, Ca), the device being characterized in that said multiplexer/demultiplexer means (2) comprise at least two secondary inlets/outlets (ES2) each connected to a respective internal channel (3), and in that the device includes at least two send and/or receive modules (R, T) each connected to a respective secondary inlet/outlet (ES2) via both-way light guide means (4, 4′) fitted with optical processor means (5, 6; 5, 6′) connected in series and capable, on order, for taking up a state selected from amongst at least a reflection state for reflecting an optical resource to the secondary inlet/outlet (ES2) that delivered it, and a transmission state for enabling an optical resource to be transferred between one of said send and/or receive modules (R, T) and said associated inlet/outlet (ES2).

2. A device according to claim 1, characterized in that each send and/or receive module is subdivided into a send module (T) and a receive module (R), and in that each of said both-way light guide means (4′) is coupled to a send module (T) and to a receive module (R) via an auxiliary coupler means (12; 13).

3. A device according to claim 2, characterized in that each auxiliary coupler means (12) is a 1 to 2 type coupler.

4. A device according to claim 2, characterized in that each auxiliary coupler means (13) is an optical circulator.

5. A device according to claim 1, characterized in that each send and/or receive module (M) is subdivided into a send module (T) and a receive module (R), and in that said both-way light guide means associated with each module (M) comprise second and third portions (15, 16) coupled firstly respectively to a send module (T) and to a receive module (R), and secondly to an auxiliary coupler means (14) connected to one of said secondary inlets/outlets (ES2).

6. A device according to claim 5, characterized in that said optical processor means (5, 6; 6′) are implanted in said second and/or third portions 15, 16).

7. A device according to claim 5 or claim 6, characterized in that it includes second coupler means (Cb) having an inlet and an outlet coupled respectively to other incoming and outgoing optical fibers (F1b, F2b), and an inlet/outlet (1b) coupled to said inlet and outlet, in that said both-way multiplexer/demultiplexer means (2) define at least two other internal channels (3b), each connected firstly to another secondary inlet/outlet (ES2), and secondly to another primary inlet/outlet (ES1b), coupled to said inlet/outlet of said second coupler means (Cb), and in that it includes at least two other send and/or receive modules (R, T) each coupled to one of the other secondary inlets/outlets (ES2) by both-way light guide means (4′) fitted with optical processor means (5, 6; 6+).

8. A device according to claim 1, characterized in that said optical processor means (5) are suitable for occupying at least one reflection state with attenuation for reflecting an optical resource while attenuating its intensity back towards the secondary inlet/outlet (ES2) that delivers it.

9. A device according to claim 1, characterized in that said optical processor means (6; 6′) are suitable for taking up at least one transmission state with attenuation for enabling a resource of attenuated intensity to be transferred between one of said send and/or receive modules (R, T) and said secondary inlet/outlet (ES2).

10. A device according to claim 8 or claim 9, characterized in that said optical processor means (5) comprise reflector means of reflection capacity that is adjustable on order.

11. A device according to claim 10, characterized in that said reflector means (5) are made in the form of a micro-electromechanical system comprising a variable-position mirror suitable for taking up at least a total reflection position, a partial transmission and/or reflection position, and a total transmission position.

12. A device according to claim 10, characterized in that said optical processor means comprise total shut-off means (6) suitable for co-operating with said reflection means (5) in order to define said state of reflection with attenuation.

13. A device according to claim 12, characterized in that said second reflector means (6) are made in the form of a micro-electromechanical system suitable for occupying at least a total shut-off position and a total transmission system.

14. A device according to claim 10, characterized in that said optical processor means (6′) comprise variable optical attenuator means suitable for co-operating with said reflector means (5) to define said state of transmission with attenuation and said state of reflection with attenuation.

15. A device according to claim 1, characterized in that said both-way multiplexer/demultiplexer means (2) define at least one other internal channel (7) connected firstly to at least one inlet (8) and secondly to another primary inlet/outlet (ES12) coupled to a second coupler means (C2) installed on said outgoing optical fiber (F2), downstream from said first coupler means (C1), in that each secondary inlet/outlet (ES2) is coupled to a receive module (R) by said both-way light guide means (4), and in that it includes at least one send module (T) coupled to an inlet (8) in such a manner as to feed it, on order, with an optical resource.

16. A device according to claim 15, characterized in that each send module (T) is coupled to an inlet (8) by one-way light guide means (9) fitted with shutter means (6) suitable for taking up, on order, one state from at least a shut state preventing access of a resource to one of said inlets (8), and a transmission state enabling an optical resource to be transferred between said send module (T) and the associated inlet (8).

17. A device according to claim 16, characterized in that said shutter means (6) are made in the form of a micro-electromechanical system suitable for taking at least a total shut-off position and a total transmission position.

18. A device according to claim 1, characterized in that said first and/or second coupler means (C1, Ca; Cb) is an optical circulator.

19. A device according to claim 1, characterized in that said both-way multiplexer/demultiplexer means (2) are implemented in the form of a wavelength selector of the AWG type.

20. A device according to claim 1, characterized in that said optical resources are wavelengths.

21. A device according to claim 1, characterized in that said optical resources are wavelength bands.
